(19) United States
(12) Patent Application Publication
(10) Pub. No.: US 2008/0190015 A1
(43) Pub. Date: Aug. 14, 2008

(54) Method and Machine for Making Fuel Pellets

(76) Inventor: Kenneth Davidsson, Uddevalla (SE)

Correspondence Address: MANELLI DENISON & SELTER, 2000 M STREET NW SUITE 700, WASHINGTON, DC, 20036-3307, US

(21) Appl. No.: 11/597,687

(22) PCT Filed: May 25, 2005
(86) PCT No.: PCT/SE2005/000774

§ 371 Date: Dec. 17, 2007

(30) Foreign Application Priority Data
May 26, 2004 (SE) 0401353-8

(51) Int. Cl. B30B 11/22

(52) U.S. Cl. 44/596; 44/636; 100/245

(57) ABSTRACT

The invention relates to a method and a machine for converting comminuted material, such as saw dust, into fuel pellets. In the method of the invention, starting material is pressed by a piston through an elongated passage having a converging cross-section. The stroke length of the piston varies over time. The machine of the invention relates to a pellets press having a variable stroke length.

### TECHNICAL FIELD

The present invention relates to a method and a machine for making fuel pellets, in which combustible material, such as saw dust or straw, is compressed by pressing of a piston through a passage having at least one converging section.

### BACKGROUND OF THE INVENTION

Wood shavings, such as sawdust and chips, result as a surplus material in e.g. saw mills. Such material can be used as a fuel. Chips and shavings however have a tendency to sinter in an incinerator. It is therefore necessary to convert the raw material into biopellets that should have a hard and smooth surface and that will flow freely when fed into an incinerator. Fuel pellets can also be made from other materials than saw dust. For example, fuel pellets can be made of straw. In order to convert the raw material into pellets, the material should be exposed to high pressure and high heat. It is known that when lignin-containing wood material is compressed at high pressure, lignin will be released and act as a natural binding agent to give the pellets a hard surface. It has however been shown that also some non-lignin-containing combustible materials can be converted to continuous fuel pellets, if the material is exposed to high enough pressure and temperature. Normally, fuel pellets are of circular cylindrical cross-section, but other types of cross-sections can in principle also be conceived, such as oval, rectangular or triangular cross-sections. Fuel pellets above a certain size are often called briquettes. For fuel pellets of circular cylindrical cross-section, it is common to use the name briquettes for pellets having a diameter above 25 mm or more. Often, briquettes can have a diameter in the range of 50-70 mm. One way of converting combustible material into fuel pellets, is by aid of a piston to press comminuted combustible material through an elongated passage having a converging section. U.S. Pat. No. 4,834,777 discloses an apparatus and a method for conversion of organic material into fuel pellets. According to that patent, a punch press is used to bring organic material into dies in which the material is compressed and extruded, or thrown out as compressed fuel pellets. The punch press comprises pistons and the dies have converging sections that cause compression of material that is pressed through the dies. As to prior art, it is also referred to WO 99/52706 that also discloses a machine for making fuel pellets, in which pistons are arranged to co-act with passages of converging cross-sections.

In methods of the above mentioned type, it is desirable that the fuel pellets produced are not too loose in structure, but that they are relatively compact. If the pellets are loose and friable, problems may arise when feeding in a pellets burner. In order for the pellets not to become to loose, a minimum force must be used for the compression, in the production. It is also desirable that the pellets are of uniform quality, such that pellets manufactured in different production periods do not end up with different properties. A known problem in connection with pellets production in which a piston presses material through an elongated passage, is that plugs may form in connection with production stops. In connection with long stops, material remaining in the elongated passage after the last stroke of the piston may form a plug that can cause problems when production is resumed. It has been noticed from experience that short stops of up to 30 minutes do not normally cause any major problems. Sometimes, production stops may however be considerably longer than 30 minutes, whereby plugs may form. A known way of counteracting the formation of plugs is to add oil or oats to the material that is compressed. Thereby, one strives to decrease the coefficient of friction between the combustible material and the inner walls of the elongated passage.

It is also desirable for the production to take place at high speed, such that the process productivity is high. Therefore, it can be desirable for the piston to be capable of performing fast operating strokes.

It is an object of the present invention to provide a method and a machine that allows for the production of fuel pellets of uniform quality and particularly of uniform hardness. Yet another object of the invention is to provide a method and a machine that counteracts or eliminates the risk of plug formation. Other objects and advantages of the inventive method and the inventive machine will be apparent from the description and drawings.

### ACCOUNT OF THE INVENTION

The present invention relates to a method for making fuel pellets, in which method combustible material is compressed by way of being pressed by successive strokes of a piston through an elongated passage. The elongated passage comprises at least one converging section and one outlet end. At least one piston stroke has a stroke length that differs from the stroke length of a previous piston stroke. Accordingly, the stroke length of the piston is variable.

According to one aspect of the invention, the stroke length is increased in connection with a production stop, such that the last piston stroke that presses out the material before the stop will be longer than the stroke immediately preceding it. In an advantageous embodiment, the last piston stroke before the stop has a stroke length that brings the piston to the outlet end of the passage.

According to a second aspect of the invention, the stroke length is instead decreased as a function of operating time, thereby counteracting variations in the frictional force that arises when the material is pressed through the passage. Thereby, the stroke length can be decreased as a function of the total operating time, but the stroke length can also be decreased as a function of operating time after the last production stop.

The invention also relates to a machine for making fuel pellets. The machine according to the invention comprises a female part having at least one elongated through passage that preferably comprises at least one converging section. The machine also comprises a male part in the form of a piston arranged to conduct operating strokes in the elongated passage, and at least one force-giving member in order to give the reciprocating movement of the piston. The stroke length of the piston is variable. The machine may then be arranged to decrease the stroke length of the piston as a function of operating time, thereby counteracting variations in the frictional force that arise when the material is pressed through the passage. The machine may also be arranged to conduct a last piston stroke before shut-off, having a longer stroke length than the stroke immediately preceding it.

Suitably, the machine according to the invention is equipped with a control device to control said at least one force-giving member. The control device can be set to decrease the time during which said at least one force-giving member pushes the piston forward in the passage, as a function of operating time. The control device can also be set, in connection with the stopping of the machine, to make the piston perform a last piston stroke of longer stroke length than the stroke immediately preceding it.

The machine according to the invention can also be provided with at least one sensor for sensing the position of the piston. Then, the sensor is suitably connected to the control device, such that the piston stroke can be affected in dependence of the reading of the sensor.

In a preferred embodiment, said at least one force-giving member is arranged during an initial part of an operating stroke to push the piston forward with a first force and a first velocity, and during a later part of the piston stroke to push the piston forward with a second force and a second velocity. Then, the second force exceeds the first force, and the second velocity decreases the first velocity. The said force-giving member may comprise two hydraulic pumps, which hydraulic pumps are of different displacements. It is of course also conceivable that the machine is equipped with a plurality of hydraulic pumps of different displacements.

The machine can be provided with a plurality of pistons, in which case the female part comprises a plurality of through passages.

### BRIEF DESCRIPTION OF THE DRAWINGS

FIG. 1 shows, partly in cross-section, parts of a conceivable embodiment of the machine according to the invention, as seen from above in a starting position for an operating stroke.

FIG. 2 shows the same machine as in FIG. 1, but here the machine is shown in an advanced phase of an operating stroke.

FIG. 3 shows the same machine as in FIGS. 1 and 2, but here seen from the side.

FIG. 4 shows a side view of an end section that is marked by a broken line circle in FIG. 3.

FIG. 5 shows, schematically and seen from the side, a cross-section of a female part with a through passage and a piston.

FIG. 6 shows a cross-section of a female part with a through passage, in which a piston pushes compressed material through the passage.

FIG. 6a shows a cross-section according to A-A in FIG. 6.

FIG. 7 shows a cross-section of a female part with a through passage, in which a piston has reached the outlet end of the passage.

FIG. 7a shows a phase during pressing out of material in a through passage.

FIG. 7b shows a cross-section according to B-B in FIG. 7.

FIG. 8 shows how a piston has passed the outlet end of a through passage.

FIG. 9 shows an end position for the piston in an operating situation in which production has just been commenced in a cold machine, and in which the female part is new and has not been subjected to any appreciable wear.

FIG. 10 shows an end position for the piston in an operating situation in which the production has been going on for some time, such that the female part has been heated up, but in which the female tool still has not been subjected to any appreciable wear.

FIG. 11 shows an end position for the piston in an operating situation in which production has just been commenced in a cold machine, but in which the female part has been used before and been subjected to wear.

FIG. 12 shows an end position for the piston in an operating situation in which the production has been going on for some time, such that the female part has been heated up, and in which the female part has been used before and been subjected to wear.

FIG. 13 is a flowchart showing advantageous control of the piston or pistons.

FIGS. 14 and 15 show the movement of the piston during the final phase of a piston stroke.

FIG. 16 shows, as seen in perspective, a conceivable embodiment of the machine according to the invention.

FIG. 17 is a cross-section of a conceivable embodiment of the piston.

FIG. 18 is a flowchart showing an alternative to the embodiment of FIG. 13.

### DETAILED DESCRIPTION OF THE INVENTION

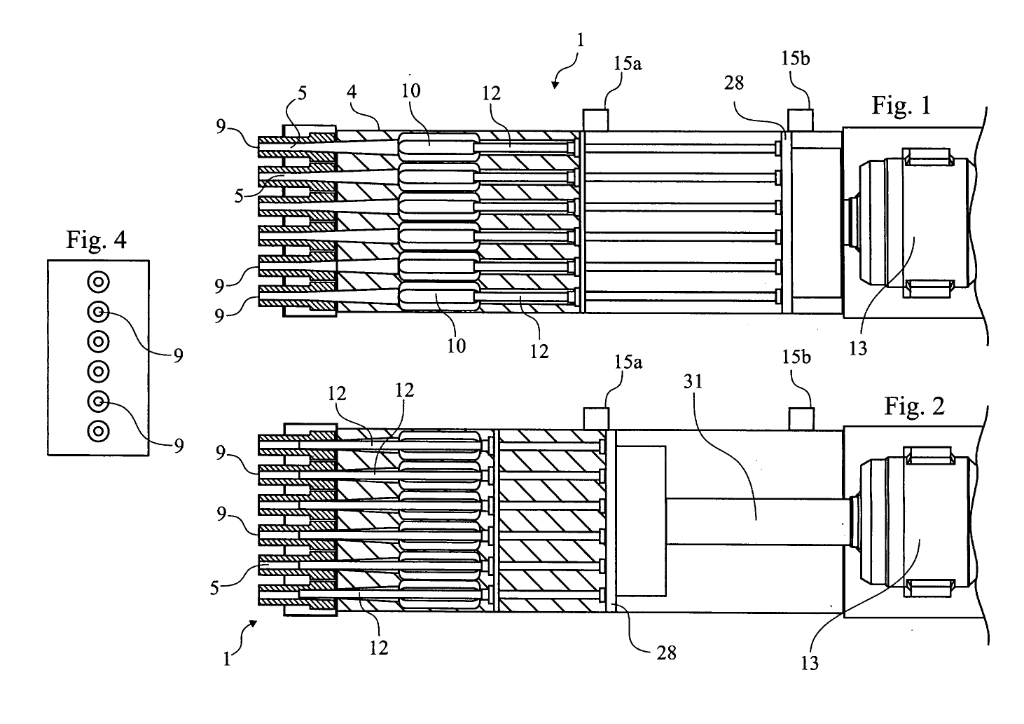

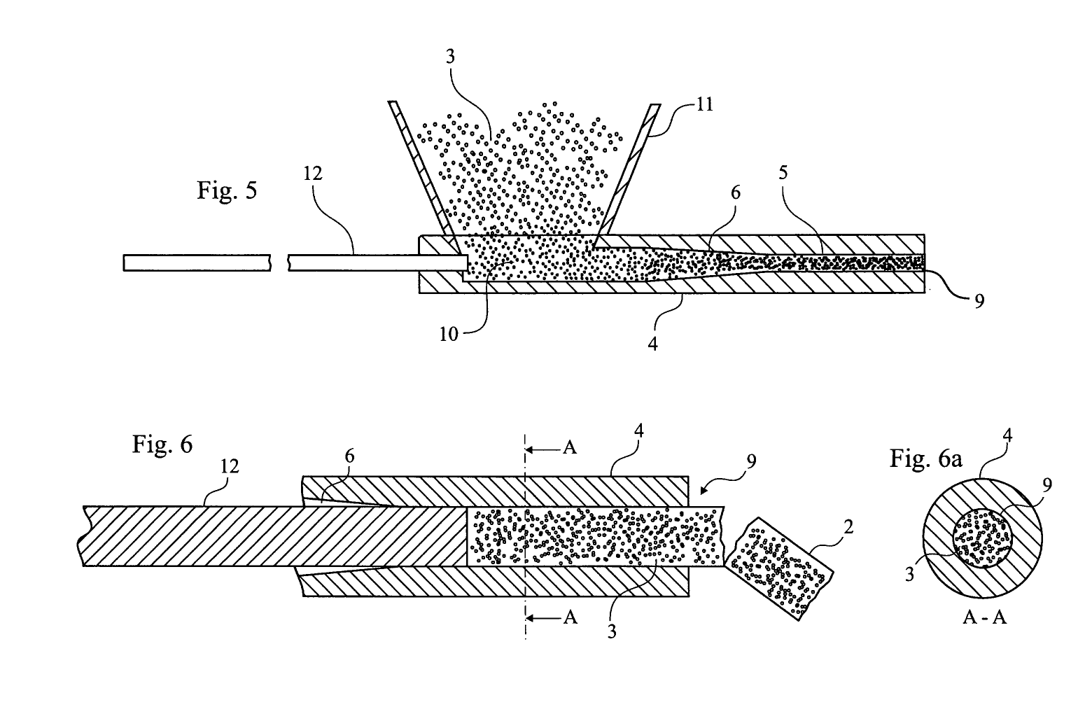

With reference to FIGS. 1-6, a machine 1 for making fuel pellets 2 is shown. As is shown in FIG. 5, combustible material 3 is fed to a hopper 10 in a machine 1 for making fuel pellets. The combustible material 3 may be e.g. saw dust, comminuted straw, bark, needles or leaves or similar. The material may also contain waste from grain processing. FIG. 5 indicates that the combustible material can be led to the hopper 10, via a funnel 11. The hopper 10 is shown in FIG. 5 to be positioned in a female part 4 (i.e. a female tool 4) having at least one elongated through passage 5 comprising at least one converging section 6. In preferred embodiments, the converging section 6 can have a conicity of about 1:10. The female part/tool 4 can be a tube/pipe 4 with one through passage, but can also be a continuous block with a plurality of through passages 5. The machine also comprises a male part 12 in the form of a piston 12 arranged to conduct operating strokes in the elongated passage 5. FIGS. 1 and 2 show that the machine 1 has a female part 4 with a plurality of through passages 5 and a plurality of pistons 12, whereby each piston 12 is arranged to co-act with one of the passages 5. Instead of a female tool 4 in the form of an integral block with a plurality of passages 5, a plurality of tubes 4 can be placed next to each other. At least one force-giving member 13 is arranged to reciprocate the piston 12 or pistons 12. The said force-giving member 13 may comprise or be composed of e.g. one or more hydraulic cylinders or hydraulic pumps. In the following, the reference number 13 will be used as a general reference for the parts or systems used to operate the piston or pistons 12. It should be understood that said force-giving member 13 may comprise a plurality of components. When the piston 12 conducts an operating stroke in the elongated passage 5, the piston 12 will push combustible material in the hopper 10, from the hopper 10 and into the elongated passage 5. The material is being compressed as it is pressed through the converging section 6. In the elongated passage 5, the material will also be compressed due to the frictional force between the compressed material and the inner wall of the passage 5, which force the piston 12 must overcome as the piston moves through the passage 5. The friction will also result in friction heat that will increase the temperature considerably. It has been found that comminuted material such as saw dust forms solid continuous pieces when the material is exposed to a high pressure and temperature. As a theoretical explanation for this phenomenon, it has been suggested that lignin is released at increased temperature and acts as a binder. It has been shown however that if the process pressure is high enough, continuous fuel pellets can be formed also from materials that contain little or no lignin. The present invention does not depend on any particular theoretical explanation, but the inventors simply observe that practical experience has shown that by a high pressure, comminuted material can be converted to continuous pellets. FIG. 6 shows the result of an operating stroke by the piston 12, in which material 3 in the passage 5 is compressed and finally pushed out through the outlet end 9, in the form of continuous fuel pellets 2.

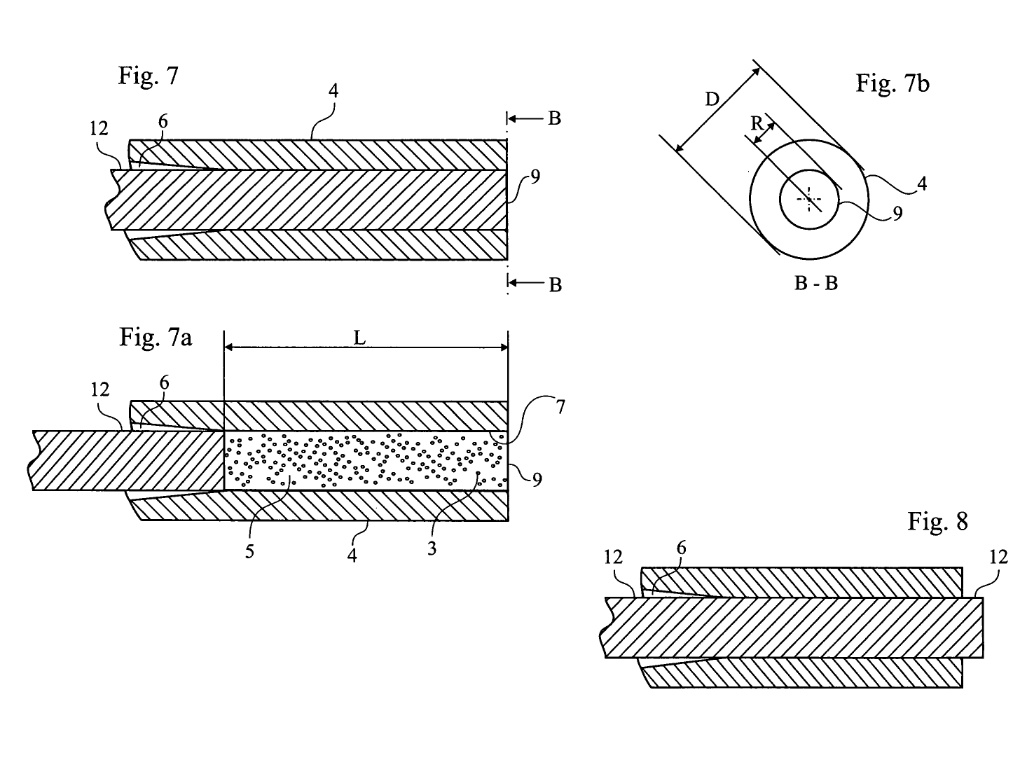

According to an advantageous aspect of the invention, the stroke length for the piston 12 is variable. If the machine comprises several pistons 12, the stroke length of at least one of the pistons 12 is suitably variable. Preferably, the stroke lengths of all pistons 12 are variable. In one conceivable embodiment, the stroke length of each individual piston 12 is individually variable. It may however be conceived that a group of pistons 12 are controlled together, such that the stroke lengths of all pistons 12 are changed in the same way. In a preferred embodiment, the machine 1 is arranged to decrease the stroke length of the piston 12 as a function of operating time, thereby counteracting variations in the frictional force that arises when the material is pressed through the passage 5. The significance of the variable stroke length will now be explained with reference to FIGS. 7a and 7b. FIG. 7a shows how a through passage 5 in a female part 4 is filled with material 3 that is pressed through the passage by a piston 12. FIG. 7a shows how a part of the passage 5 that is filled with material 3 extends over the length L, which in the figure corresponds to the length from the end of the piston 12 to the outlet end 9 of the passage 5. In the figure, it is shown that the material extends precisely to the outlet end 9, but it should be understood that this is a simplification of reality. It is realised that the material 3 inside the passage 5 is converted by compression to fuel pellets. Due to the compression, there is a certain pressure inside the passage. Of course, there is also a certain friction between the material 3 and the inner wall 7 of the passage 5. In order for the piston 12 to be able to push the material 3 through the passage 5, the piston 12 must overcome the frictional force. When the passage 5 is of circular cylindrical cross-section with the radius R and the diameter D, the frictional force can be expressed by the equation F=μPπDL, in which F=frictional force, P=pressure, μ=coefficient of friction between the material 3 and the wall 7 of the passage. It is realised that π is the well known mathematical constant that is often approximated with or rounded to π=3.14. In the equation, π and D are constants. As is clear from the equation, the frictional force is dependent of the length L, which means that a changed stroke length of the piston 12 affects the frictional force. If the piston 12 reaches far into the passage 5 at each operating stroke, this means that the length L will be small at the end of the piston stroke, and hence the frictional force will be low. If, on the other hand, the piston makes short strokes into the passage 5, this will mean that the length L at the end of the operating stroke will be larger, which leads to a higher frictional force. At short operating strokes, the machine will hence operate at a higher frictional force. As explained above, the frictional force contributes to the compression of the material. A higher frictional force leads to the material being more compressed than at a lower frictional force. Therefore, a decreased stroke length of the piston 12 will increase the compressing of the material. In the same way, an increased stroke length will result in decreased compressing of the combustible material. Hence, the compressing can be controlled by controlling the stroke length. If the degree of compression is too low, the fuel pellets produced will not be adequately compact. This can result in that the pellets crumble, which in turn can result in problems in connection with the feeding of fuel pellets in a pellets burner. In the equation above, F=μPπDL, it can not be assumed that the coefficient of friction π is constant over time, but the inventors have found that the coefficient of friction may vary. Firstly, it has been found that the coefficient of friction varies as a function of the temperature in the passage 5 of the female part 4. When the machine 1 is started, it initially has the same temperature as the surroundings and can be considered as being “cold”. When the machine 1 is taken into operation, the friction in the passage 5 will however result in frictional heat which leads to an increase in temperature. The machine will reach an operating temperature, at which the machine can be considered as being “hot”. The coefficient of friction μ is lower when the machine is hot as compared to when it is cold. The inventors have found that in order to counteract the decreasing frictional force F as the machine gets hot, the stroke length should be shorter at hot conditions than at cold conditions when the machine is started up. Secondly, the coefficient of friction μ tends to be lowered over time, as a result of wear during operation having a polishing effect on the inner wall 7 of the passage 5. The friction is relatively high when the machine is new and just has been taken into operation for the first time. After months or years of use, the friction will be lower. Therefore, the inventors have found that the stroke length should be decreased when the machine has been subjected to wear for a long time, independent of whether the machine operates at hot or cold conditions.

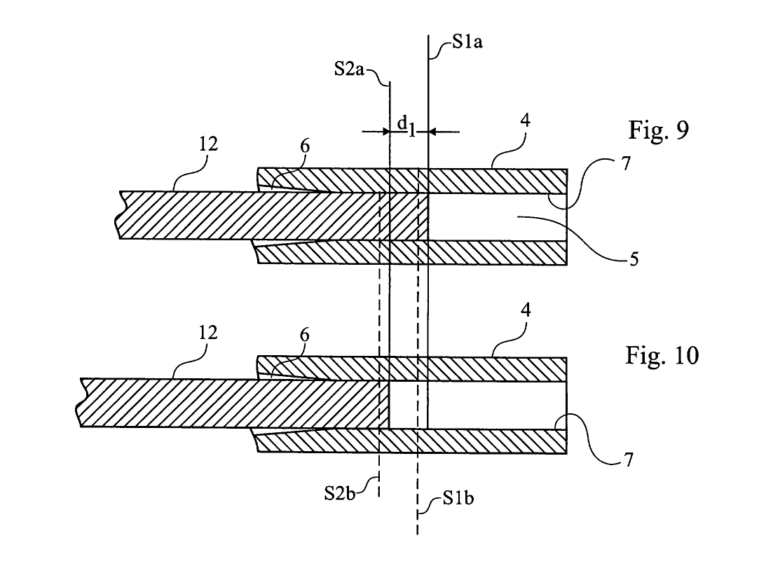

It is now referred to FIG. 9. and FIG. 10. FIG. 9 represents the condition of a new machine that has not yet been worn, and which machine has just been started up. Accordingly, the machine is in a “cold” condition. It should be understood that the passage 5 in the female part 4 contains material that is being compressed into pellets, but in order to clarify other aspects the material is not shown in the figure. In FIG. 9, the piston 12 has just completed an operating stroke and it has reached its end position that is marked by the line S1a. FIG. 10 shows the situation after the machine has operated to reach its “hot” condition. Then, the operating stroke has been reduced such that the piston 12 reaches its end position earlier, which is marked by the line S2a in FIG. 10. The difference in stroke length is shown as d₁. A reduction of the frictional force is counteracted by decreasing the stroke length. Thereby, the degree of compression for the fuel pellets produced can be maintained unchanged or essentially unchanged.

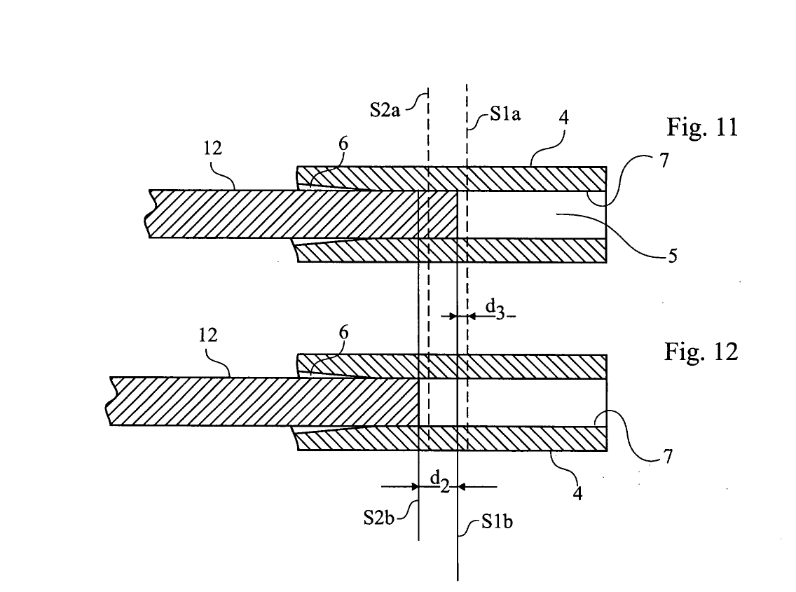

It is now referred to FIG. 11. and FIG. 12. FIG. 11 corresponds to a machine that has been in operation for a long time and that has been subjected to wear. The machine in FIG. 11 has just been started up, and hence it is “cold”. The piston 12 will now reach its end position at the line S1b. In FIG. 11, the end position S1a for a new machine has also been indicated. As is clear from the figure, position S1b is reached earlier than position S1a. Accordingly, it can be seen from a comparison of FIG. 11 and FIG. 12, that the stroke length for a “cold” machine has been decreased by the distance d₃. Hence, the stroke length is shorter than for a new machine. FIG. 12 shows the conditions of a machine that has been subjected to wear that has ground the wall 7 of the passage 5, and that moreover is in its “hot” condition. Here, the end position of the piston 12 is shown by the line S2b. As is clear from FIG. 12, the stroke length has accordingly been reduced compared to that shown in FIG. 11. The difference in stroke length has been marked as d₂ in FIG. 12. By reducing the operating stroke of the piston 12 as the machine is subjected to wear, one may counteract the fact that the compressing degree decreases over time. The inventors have found that in practice, the difference d₁, d₂ in stroke length can be about 5 mm when comparing a cold machine and a hot machine. As an example, it can be mentioned that at the start-up of a new machine, it can be conceived that the piston moves 15 mm into the passage 5, while it might move about 10 mm in the passage 5 when the machine is hot.

It should be understood that when “operating time” is discussed in the present application, this operating time can be measured as a number of operating strokes conducted by the piston. In particular when the total operating time is discussed, which leads to a wear of the inner wall 7 of the through passage 5, it is primarily the number of operating strokes that is decisive.

It should be understood that controlling the stroke length not necessarily has to result in a decrease of the stroke length. If for example it is found that the compression of the produced fuel pellets is too high, the stroke length can be increased in accordance with the method according to the invention, such that the compressing degree decreases.

Another advantageous embodiment will now be explained with reference to FIGS. 7, 7a and 8. The machine 1 can advantageously be arranged in connection with its shutting-off to conduct a piston stroke of longer stroke length than the stroke immediately preceding it. Hence, FIG. 7a shows how a certain amount of material 3 is in the passage 5 of the female part 4, at the end of a piston stroke. The machine is now to be shut off. FIG. 7 shows how the piston 12 is allowed to move all the way to the outlet end 9 of the passage 9, in connection with the shutting-off. Then, all material in the passage 5 will be pushed out, and no material remains in the passage 5, which material might otherwise form a plug. FIG. 8 shows that the piston 12 even has passed beyond the outlet end 9. It should be understood that the piston 12 not necessarily has to go all the way to the outlet end 9. If the piston 12 simply conducts a longer stroke in connection with the shutting-off, but does not go all the way to the end, a certain amount of material will for certain remain in the passage 5, but the remaining amount of material is less, and if a plug is formed it will be shorter and easier to push out in connection with the shutting-off. Hence, by conducting a longer piston stroke in connection with the shutting-off, the formation of plugs is counteracted.

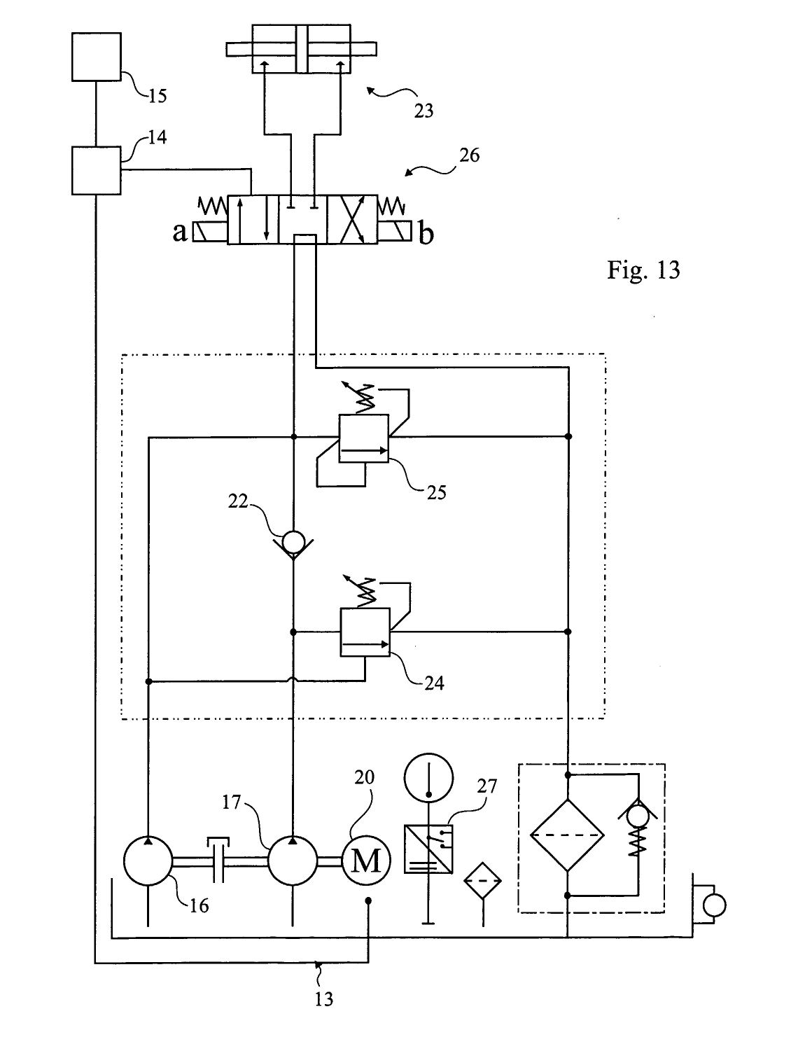

In advantageous embodiments, the machine 1 can be equipped with a control device for control of said at least one force-giving member 13. The control device is symbolically indicated by reference number 14 in FIG. 13. The control device can be a programmable so called PLC system (PLC=Programmable Logic Control). The control device 14 is suitably set to decrease the time during which said at least one force-giving member 13 pushes the piston 12 forward in the passage 5, as a function of operating time. The control device 14 can be set to change the stroke length after a predetermined period of time. This period of time, which can be counted for example as number of piston strokes or minutes and hours, can be set from experience. The periods of time can be set as fixed predetermined values that among other things depend on which material is used for the pellets production. The periods of time can vary depending on if the material is e.g. saw dust, straw or needles. The control device 14 can be set to change the stroke length by a predetermined value after a certain time period. Alternatively, it may be conceived that the stroke length is changed continuously. Instead of setting a certain time period, the stroke length can be controlled from some other parameter, such as a temperature measured for the female tool 4.

It should be understood that it is not necessary to have a programmable control device 14 in order to use the invention. Instead, an attendant can inspect the pellets in connection with the production. When the attendant is of the opinion that the fuel pellets produced are about to become too loose, the attendant may manually reduce the stroke length of the piston, e.g. by turning a potentiometer that controls the stroke length.

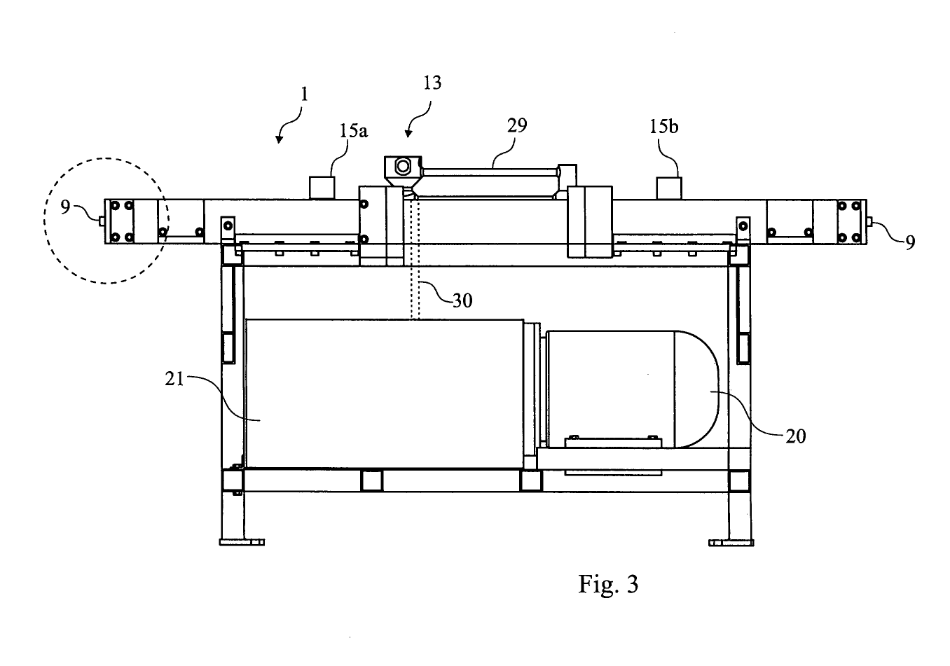

As indicated in FIGS. 1, 2 and 13, the machine 1 can be provided with at least one sensor 15a, 15b. The sensor or sensors 15a, 15b are intended to sense the position of the piston 12, and the sensor 15 is connected to the control device 14 such that the stroke of the piston 12 can be externally affected by the read of the sensor 15. FIGS. 1 and 2 show that the machine 1 is provided with a front sensor 15a as well as a rear sensor 15b. FIGS. 1 and 2 show that both sensors 15a, 15b are positioned on the same side of the force-giving member 13. This representation is to be seen primarily as a schematic representation. As is clear from FIG. 3, the machine can be arranged to conduct piston strokes in two directions (to the right and to the left in FIG. 3). Then, it may be suitable to have one sensor 15a on the left part of the machine (the part that makes operating strokes to the left in FIG. 3) and one sensor 15b on the right part of the machine (the part that makes operating strokes to the right in FIG. 3). The sensor 15a on the left side of the machine will detect the position of one or more pistons 12 that make(s) operating strokes to the left and the sensor 15b on the right side of the machine detects the position of one or more pistons 12 that make(s) operating strokes to the right (not shown in FIGS. 1 and 2). Advantageously, this can be done by a sensor 15a giving a signal when a piston 12 or a group of pistons 12 pass(es) the sensor 15a during an operating stroke to the left in FIG. 3. Correspondingly, a second sensor 15b can give a signal when a piston 12 or a group of pistons 12 pass(es) the sensor 15b during an operating stroke to the right in FIG. 3. The sensor or sensors 15a, 15b can e.g. be an inductive contact free sensor 15 that senses when a metal object gets in its vicinity. If a piston 12 is prevented to move by some hard object (such as a nut) having ended up in the passage 5, this is indicated by the sensor 15a, 15b not being affected at the point of time that it should, since then the piston 12 will not move as it should. Then, the control device 14 can shut off the system and give an error signal in order for an attendant to remove the obstacle or to take other action. Optionally, another sensor (not shown) can be positioned at the middle of the machine in order to sense when the pistons are at their rest positions. It should be understood however that the rest position need not necessarily be the same as the middle position, and that the sensor that is to sense when the pistons are at their rest positions need not necessarily be positioned at the middle of the machine.

It should also be understood that the control device 14 for controlling of said at least one force-giving member 13 can be set also to make the piston 12 conduct a last piston stroke of longer length than the immediately preceding stroke, in connection with the shutting-off of the machine 1.

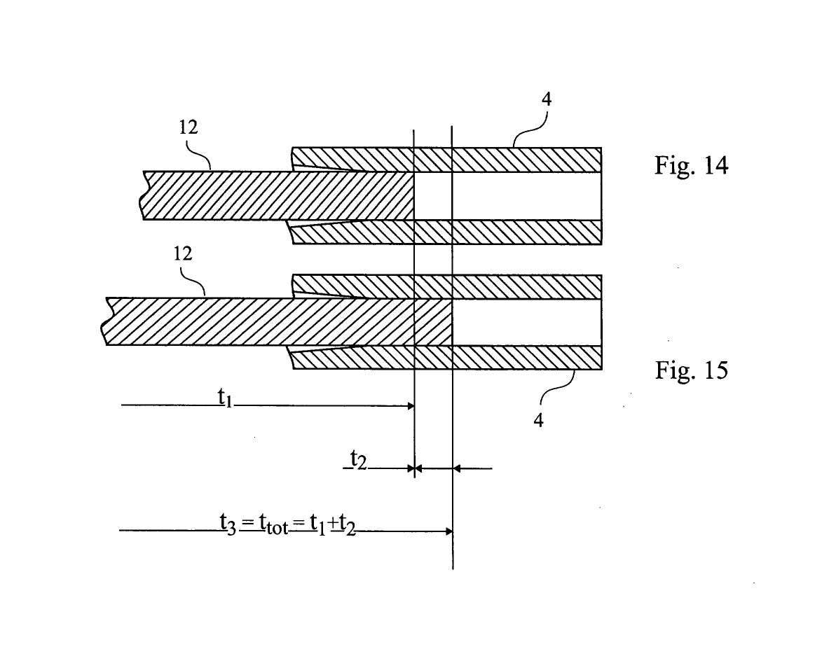

Another advantageous embodiment of the inventive method and the inventive machine will now be explained with reference to FIGS. 13, 14 and 15. As indicated above, the piston or pistons 12 can be operated by one or more hydraulic cylinders. Such hydraulic cylinders may suitably operate with hydraulic oil. FIG. 13 also shows schematically that a hydraulic cylinder 23 can be connected to two hydraulic pumps 16 and 17 that can be operated by an electric motor 20 e.g. Physically, the hydraulic pumps 16, 17 can be positioned in a tank 21 that contains oil, see FIG. 3. FIG. 3 also shows symbolically that hydraulic oil can be led from the tank 21, through a schematically indicated conduit 30 that leads to the parts of the force-giving member 13 that act more directly on the piston or pistons 12. It is realised that the hydraulic cylinder 23 can form at least a part of the above mentioned at least one force-giving member 13 that is arranged to operate the piston. According to an advantageous aspect of the invention, the hydraulic cylinder 23 is arranged during an initial part of an operating stroke to push the piston 12 forward with a first force and a first velocity and during a later part of the piston stroke to push the piston 12 forward with a second force and a second velocity, the second force being greater than the first force and the second velocity being less than the first velocity. For the machine 1 to operate fast and maintain a high productivity, it is desirable that the piston or pistons 12 are fast moving. It is however also essential that the piston or pistons 12 can achieve an adequately high force when material is pressed through the passage. As is evident from FIG. 13, the hydraulic cylinder 23 is driven by at least two hydraulic pumps 16, 17. These pumps are of different displacements, such that the pump 16 has a lower displacement and the pump 17 has a higher displacement. Both pumps 16, 17 are connected to the hydraulic cylinder 23 via conduits that are schematically indicated in FIG. 13. The hydraulic system also comprises a non return valve 22 in the conduit from the pump 17 of the higher displacement and to the hydraulic cylinder 23. The hydraulic system also comprises pressure regulators 24, 25. A first pressure regulator 25 can be set for a high pressure, such as expediently 150 bar. A second pressure regulator 24 can be set for a lower pressure, such as expediently 50 bar. In an initial stage of an operating stroke for a piston 12, the material 3 in the hopper 10 has not been much compressed, and the piston 12 does not need a large force to move forward. Then, the hydraulic cylinder 23 need not operate at a large force. In the stage, the hydraulic cylinder is driven by both pumps 16, 17. When the material 3 that is to be converted to fuel pellets has reached a certain degree of compression, the pressure in the hydraulic cylinder 23 will be too high for both pumps to be able to drive the hydraulic cylinder. The function of the non return valve 22 is to prevent the oil flow from going back to the tank. Instead of being driven by both pumps, the hydraulic cylinder 23 will now be driven by the pump 16 of the lower displacement, since this pump is able to operate against a higher pressure in the system. It is realised that the result is that the piston 12 will move at a relatively high velocity during an initial stage, and during a final stage its velocity will be lower and the force will be higher. In the hydraulic system there is also a hydraulic direction valve 26 that determines the direction of the hydraulic cylinder 23. Depending on the position of the direction valve 26, the hydraulic cylinder 23 can push the piston 12 forward in the passage 5, or pull it backwards to the initial position for a new stroke of the piston. The pulling back of the piston 12 in a “negative stroke” can also be used to press pellets if using a machine that operates in two directions, as is suggested in FIG. 3. A “positive stroke” in one direction will then be a “negative stroke” as seen in the other direction, i.e. that it will pull the piston or pistons 12 back. The position of the direction valve 26 can be controlled by the control device 14. In a preferred embodiment, this will take place by the position of the direction valve being controlled by signals from one or more sensors 15 for sensing the position of the piston 12. It is also conceivable that one or more sensors 15 for sensing the position of the piston 12 are directly coupled to the direction valve 26 such that the direction valve 26 will switch over automatically at certain positions of the piston 12. Then, the direction valve 26 can switch over slightly before the piston 12 has reached the end (end position) of its operating stroke, taking into account that it takes some time to brake the movement of the piston 12 before the piston can begin to move in the opposite direction. The controlling of the stroke length of the piston 12 can take place by changing the time lapse from the detection of the piston by the sensor 15a, 15b, and up to the switch over of the direction valve 26. It should be realised however that embodiments of the machine according to the invention and the method according to the invention can be controlled completely without any sensors, whereby the direction valve 26 is instead controlled only by a timer. Reference number 27 denotes a temperature sensor for the hydraulic oil. Suitably, the temperature sensor 27 is connected to the control device 14. It is now referred to FIGS. 14. and 15. During a first time distance t₁, the piston 12 will move during its piston stroke at a first velocity that is relatively high, while the force of the piston stroke is relatively low. At a certain position of the piston 12, the pressure will be too high and during the remaining distance t₂ the hydraulic cylinder 23 will be driven only by the pump 16 of the lower displacement. The total length of the piston stroke is denoted t₃. By the machine 1 according to the invention being provided with two pumps of different displacement, the advantage is thus attained that the velocity can be high during a large part of the operating stroke of the piston 12, at the same time as the piston 12 can operate at a high pressure when required at the end of a piston stroke. It should be understood that normally the distance t₂ is relatively small. If the total stroke length t₃ is about 200 mm, the distance t₂ can be in the magnitude of 10 mm.

It should be understood that suitably the hydraulic cylinder 23 has a hydraulic piston 31 that is indicated in FIG. 2. FIGS. 1 and 2 show that the hydraulic piston 31 can be connected to a plate 28 that in turn can be fixedly connected with the rear end of a plurality of operating pistons 12. FIG. 3 also shows an additional conduit 29 for hydraulic oil, which can be used in connection with an operating stroke to the right in FIG. 3.

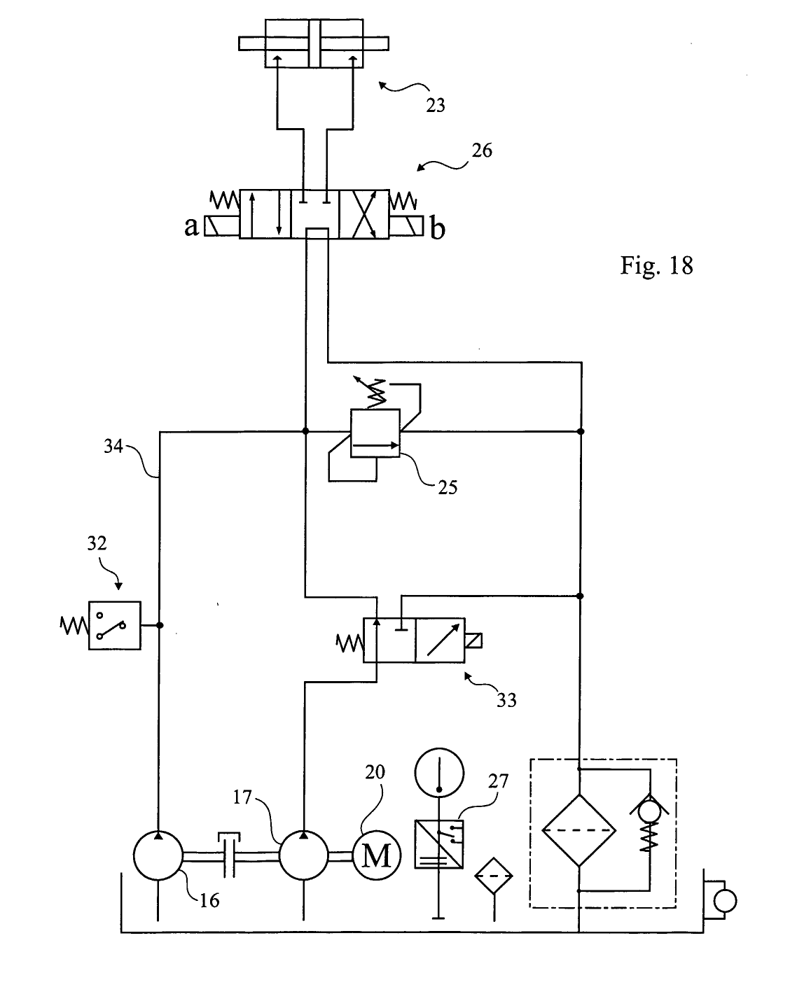

With reference to FIG. 18, an embodiment will now be described that is an alternative to the embodiment shown in FIG. 13. As is the embodiment according to FIG. 13, the hydraulic cylinder 23 is controlled by a direction valve 26. There is also a second direction valve 33 in the conduit from the pump 17 with a large displacement. It should also be realised that also in the embodiment according to FIG. 18, a control device 14 such as a PLC-system can be used. The direction valve 26 receives its pressure and oil flow from the two pumps 16, 17 of the hydraulic unit. When the direction valve 26 is unaffected, oil will just flow straight through and back to the tank without affecting the hydraulic cylinder 23. When the direction valve 26 receives a signal to assume position “a” or “b”, the direction valve 26 will assume the position to affect the hydraulic cylinder 23 to conduct a positive or negative stroke. If the resistance to the movement of the hydraulic cylinder 23 increases, the pressure will increase in the conduit 34 for hydraulic oil. A pressostate 32 is mounted in the conduit 34. The pressostate 32 is a pressure switch with a micro switch that changes position at a predetermined pressure. When the pressure exceeds a pre-set value, the pressostate 32 will switch, and an electric signal from the pressostate 32 will signal to the control device/PLC-system that the pressure exceeds the pre-set value. The PLC-system can then signal to the second direction valve 33 to change position. Hydraulic oil from the pump 17 of large displacement will then flow directly to the tank without passing the first direction valve 26. In this position, only the pump 16 of small displacement will provide the hydraulic cylinder 23 with flow and pressure, via the first direction valve 26. Accordingly, the embodiment according to FIG. 18 do not require the non return valve 22 shown in FIG. 13.

It should be understood that the concept of two hydraulic pumps 16, 17 of different displacement can be used independent of whether the stroke length is controlled as a function of operating time or not. It should also be understood that the principle shown here, with two hydraulic pumps, can be used also with more than two pumps. Accordingly, e.g. three hydraulic pumps of different displacements can be used. For example, one may use a first hydraulic pump of low displacement, a second hydraulic pump of a somewhat higher displacement and a third hydraulic pump of a displacement that is higher than the displacement of the second hydraulic pump. Correspondingly, four, five or even more hydraulic pumps can be conceived. The invention can also be seen more generally as a method of operating a pellets press, in which the piston 12 is pushed at high velocity but at low force, in the initial phase of an operating stroke, and later during the stroke, the piston is pushed at high force and low velocity. This principle can be used independent of whether the stroke length is controlled or not. It should also be realised that the invention can be seen in terms of a machine for making pellets, in which hydraulic pumps of different displacements are used whether or not the machine is designed for a variable stroke length. By using hydraulic pumps of different displacements, the advantage is attained among other things that energy consumption can be reduced.

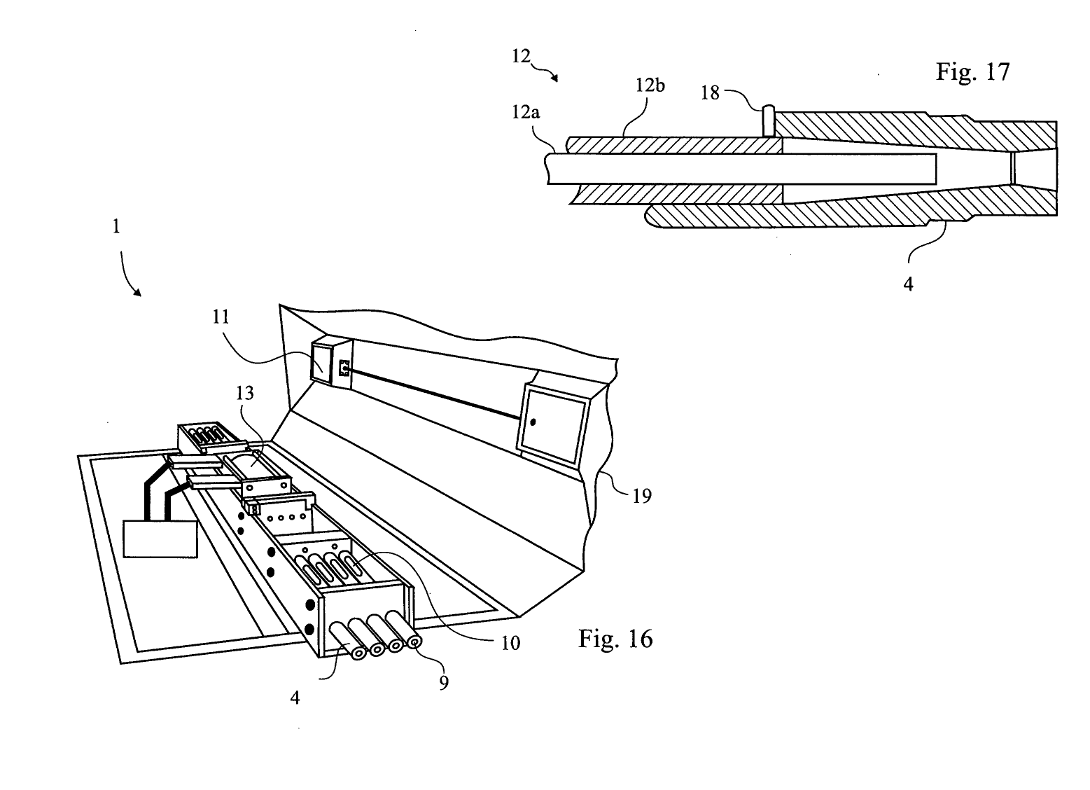

FIG. 16 shows in perspective a conceivable embodiment that differs somewhat from the embodiment according to FIGS. 1-3. The embodiment shown in FIG. 16 does not use an integral female tool 4 with a plurality of passages. Instead, the machine has a plurality of separate female parts 4 in the form of tubes 4. The machine shown in FIG. 16 also has a tiltable cover 19 provided with funnels 11 for the feeding to the hoppers 10 of chips or other material.

As is shown in FIGS. 3 and 16, the machine 1 can be designed to conduct operating strokes in two directions. When the machine conducts an operating stroke in one direction, such that a set of operating pistons 12 move forward, this will simultaneously result in that another set of pistons are pulled back. This means that the same hydraulic system can be used.

FIG. 17 shows a conceivable embodiment of a piston 12. The piston 12 shown in FIG. 17 is a two-part piston comprising an inner piston part 12a and an outer piston part 12b. The piston parts 12a, 12b can be connected to a not shown friction coupling. The outer piston part 12b is provided with a stop 18, which stops the movement of the outer piston part as it meets an edge of the female part 4, such that only the inner piston part 12a participates in a final phase of the operating stroke of the piston. It should be understood however that this is only one example of a conceivable design of the piston 12. The present machine and method can of course also be used with a piston 12 that is not in two pieces.

When making fuel pellets 2 according to the method of the invention, combustible material 3 will accordingly be compressed by the material 3 being pressed by a piston 12 in successive piston strokes through an elongated passage 5. As described above, the passage 5 comprises at least one converging section 6, and an outlet end 9. According to the method of the invention, at least one piston stroke has a stroke length that differs from the stroke length of a previous piston stroke. According to one aspect of the method of the invention, the stroke length is increased in connection with a production stop, such that the last piston stroke that presses out the material before the stop will be longer than the stroke immediately preceding it. Then, the last piston stroke before the stop can have a stroke length that takes the piston 12 to the outlet end of the passage 5, or even further.

According to another aspect of the method of the invention, the stroke length is instead decreased as a function of operating time, thereby counteracting variations in the frictional force that arises when the material is pressed through the passage 5. This can be done by decreasing the stroke length as a function of total operating time, or as a function of operating time since the last production stop. Normally, the stroke length is decreased as a function both of total operating time and of operating time since the last production stop. Of course, it is also conceivable that the stroke length is increased instead, if this should be seen as fit, for example to decrease the degree of compression.

It should be understood that the principle of controlling the stroke length of the piston, in order to counteract variations in frictional force, can be used whether or not an extra long operating stroke is conducted in connection with the shutting-off. It should also be understood that the concept of conducting an extra long operating stroke in connection with the shutting-off, can be used whether or not the stroke length is controlled for the rest of the time. However, it is of course advantageous to apply both concepts at the same time. By providing a machine of variable stroke length, both these principles can be used, separately or at the same time.

By the invention, the advantage is attained among other things that changes in frictional force can be counteracted such that a constant or nearly constant degree of compression can be maintained in the production of fuel pellets. Thereby, fuel pellets are achieved the properties of which are not so dependent of at which time point during the production process that they have been produced.

1-15. (canceled)

16. A method for making fuel pellets comprising:
compressing combustible material by way of being pressed by successive strokes of a piston through an elongated passage that comprises at least one converging section and an outlet end, wherein at least one piston stroke has a stroke length that differs from the stroke length of a previous piston stroke.

17. A method according to claim 16, wherein the stroke length is increased in connection with a production stop, such that the last piston stroke that presses out material before the stop will be longer than the stroke immediately preceding it.

18. A method according to claim 17, wherein the last piston stroke before the stop has a stroke length that takes the piston to the outlet end of the passage.

19. A method according to claim 16, wherein the stroke length is decreased as a function of operating time, thereby counteracting variations in the frictional force that arises when the material is pressed through the passage.

20. A method according to claim 19, wherein the stroke length is decreased as a function of total operating time.

21. A method according to claim 19, wherein the stroke length is decreased as a function of operating time since the last production stop.

22. A machine for making fuel pellets comprising:
a female part having at least one elongated through passage that comprises at least one converging section;
a piston arranged to conduct operating strokes in the elongated passage; and
at least one force-giving member for reciprocating the piston, wherein the stroke length of the piston is variable.

23. A machine according to claim 22, wherein the machine is arranged to decrease the stroke length of the piston as a function of operating time, thereby counteracting variations in the frictional force that arises when the material is pressed through the passage.

24. A machine according to claim 22, wherein the machine is arranged to conduct a last piston stroke before shut-off, having a longer stroke length than the stroke immediately preceding it.

25. A machine according to claim 24, wherein the machine is equipped with a control device for control of said at least one force-giving member, which control device is set as a function of operating time to decrease the time during which said at least one force-giving member pushes the piston forward in the passage.

26. A machine according to claim 15, wherein the machine is provided with at least one sensor for sensing the position of the piston, which sensor is connected to the control device such that the strokes of the piston can be externally affected by the read of the sensor.

27. A machine according to claim 22, wherein the machine is equipped with a control device for controlling said at least one force-giving member, which control device is set to make the piston conduct a last piston stroke of longer length than the immediately preceding stroke, in connection with the shutting-off of the machine.

28. A machine according to claim 22, wherein said at least one force-giving member is arranged during an initial part of an operating stroke to push the piston forward with a first force and a first velocity and during a later part of the piston stroke to push the piston forward with a second force and a second velocity, the second force being greater than the first force and the second velocity being less than the first velocity.

29. A machine according to claim 28, wherein said at least one force-giving member comprises two hydraulic pumps, which hydraulic pumps are of different displacements.

30. A machine according to claim 22, wherein said female part comprises a plurality of through passages, and in that the machine comprises a plurality of pistons.
